(19) United States
(12) Patent Application Publication
(10) Pub. No.: US 2009/0153290 A1
(43) Pub. Date: Jun. 18, 2009

(54) Secure interface for access control systems

(75) Inventor: Kirk B. Bierach, Saratoga, CA (US)

Correspondence Address: Nixon Peabody LLP, 200 Page Mill Road, Palo Alto, CA, 94306, US

(73) Assignee: Farpointe Data, Inc., a California Corporation

(21) Appl. No.: 12/002,145

(22) Filed: Dec. 14, 2007

(51) Int. Cl. H04L 9/32

(52) U.S. Cl. 340/5.6

(57) ABSTRACT

An access control system and methods utilizing secure Wiegand communication interface are disclosed. In one example embodiment, an access control system includes an a plurality of RFID cards, a RFID reader and an access controller. The RFID reader collects user identification information communicated thereto via RFID cards and forwards it to the remote access controller. The access controller process the received identification information and determines whether to grant RFID card holder access to a restricted area or service. The RFID reader communicates with the access controller via a secure Wiegand interfaces, which utilized RFID reader identifiers, message sequence numbers and data encryption techniques to secure data transmissions between the RFID reader and access controller from various types of attacks.

### TECHNICAL FIELD

The present disclosure relates generally to access control systems and more specifically to secure radio-frequency identification (RFID) applications.

### BACKGROUND

Due to relative simplicity and low cost of manufacturing, RFID systems have gained a widespread use. For instance, RFID technology is frequently used in security applications where RFID cards are implemented to provide access to restricted areas or services. Typically, an RFID system includes one or more RFID cards (also known as contactless IC cards), which are provided to system users. An RFID reader (also known as an RFID interrogator) receives RF (radio frequency) signals from proximate RFID cards, decodes identification information from the received RF signals and forwards it to a remote access controller. The access controller, which typically includes a computer system located in a secure area 150, authenticates an RFID card holder based on the provided identification information to determine whether to grant the card holder access to the restricted area or service.

The “Wiegand” interface is one of the most popular and frequently used communication standards for interfacing RFID readers and remote access controllers. Typically, the Wiegand interface provides for data transmission using four conductors—a power line (+V), a ground line (GND), a DØ line (pulse means data=‘0’), and a D1 line (pulse means data=‘1’). The Wiegand data lines (DØ, D1) are used to transmit the RFID information as a binary stream of ‘1’s and ‘0’s. The data is typically formatted as 26-bit messages, however, smaller or larger messages may be used depending on the application in which the Wiegand interface is being used. Thus, due to its simplicity and versatility, the Wiegand interface has become a de facto standard in many RFID applications for communication between RFID readers and access controllers. Herein Wiegand-type interfaces are intended to include Wiegand compliant interfaces as well as similar interfaces supporting data transmission on one or more lines provided in parallel with power lines providing power to a card reader.

However, the typical Wiegand interface is susceptible to various types of security attacks. For example, it is possible for an intruder to remove an RFID reader from the wall mount, and tap directly into the Wiegand data lines with a “sniffer” device. In addition to the data lines, the sniffer device can use the Wiegand+V and GND lines to power itself. Such a sniffer device could be configured to capture and record Wiegand data messages, which would allow for playback at any RFID enabled door that accepts the card data. Such a device could be remotely controlled by means of a secondary wireless interface, which would eliminate the need to subsequently remove the reader or otherwise establish a control mechanism to initiate a playback sequence. This data could be played back at any time, allowing unauthorized entry. For example, an intruder could flash a counterfeit badge at the RFID reader, then press a button on a hidden transmitter, which would inform a secreted circuit tied in parallel with the RFID reader to send a recorded Wiegand message to the access controller. Accordingly, there is a need to provide more security to such access control systems.

### OVERVIEW

The access control systems and methods disclosed herein utilize a secure Wiegand or similar type of communication interface. In one example embodiment, an access control system includes at least one authorized RFID card, an RFID reader and an access controller. The RFID reader may be located in an unsecure area and accessible to RFID card holders. The RFID reader receives identification information associated with the RFID card and communicated thereto via the RFID card and forwards it to the access controller for processing. The access controller may be located in a secure, remote area. The access controller processes the received identification information and determines whether to grant access to the restricted area or service. In one example embodiment, the RFID reader communicates with the access controller via a secure Wiegand interface using techniques described herein.

In one example embodiment, the RFID reader includes an RFID card interface configured to receive an RFID signal including at least identification data associated with a holder of an RFID card. The reader further includes a controller, configured to extract the identification data from the received RFID signal, calculate the message sequence number, and generate an access controller message based at least in part on the identification data. The message may further include an RFID reader identifier and a message sequence number. The reader further includes an encryption engine configured to encrypt the generated message (for example, using a block cipher or a public-key encryption algorithm, or the like). An access controller interface is configured to transmit the encrypted message to the remote access controller.

In one example embodiment, the access controller includes an RFID reader interface configured to receive the encrypted message and a decryption engine configured to decrypt the received message. The access controller further includes an authentication engine configured to authenticate decrypted messages based on at least the RFID reader identifier and the message sequence number. The authentication engine is configured to compare the message sequence number retrieved from the received message with, for example, a previously received and stored message sequence number. The authentication engine is further configured to compare the RFID reader identifier retrieved from the received message with one or more stored RFID reader identifiers. The access controller is further configured to determine whether identification data received and decrypted corresponds to an authorized RFID card. The access controller further includes circuitry for generating an access control signal granting access to the restricted areas or services responsive to the presentation of an authorized RFID card.

In one example embodiment, an access control method may be implemented as follows: an RFID card signal from an RFID card is received at an RFID card reader. The RFID card signal includes at least identification data associated with the RFID card. The RFID card reader extracts the identification data from the RFID card signal and generates an access control message based at least in part on the identification data, an RFID reader identifier associated with the RFID card reader and a message sequence number associated uniquely with the access control message. The access control message is encrypted at the RFID card reader (e.g., using a block cipher, public-key encryption algorithm, or the like) and the encrypted access control message is sent to a remote access controller via a Wiegand or similar interface. The message sequence number may be a sequential number (which may repeat after a certain number of messages) or may be a pseudo-random number generated by a pseudo-random number generating algorithm (which may also repeat after a certain number of messages. A time/date stamp may be used for the message sequence number if such data is available. The message sequence number changes after each message.

In another example embodiment, an access control method may be implemented as follows: an access controller receives an encrypted RFID reader message over a Wiegand-type RFID reader interface from a remote RFID reader. The access controller then decrypts the RFID reader message and retrieves the RFID reader identifier and/or the message sequence number. The access controller authenticates the RFID reader message based at least in part by comparing (1) the retrieved message sequence number with the stored (or calculated) message sequence number and/or (2) the retrieved RFID reader identifier with the stored RFID reader identifier. Upon authentication an access control signal is sent to enable access (e.g., opening or unlocking a door, or the like).

### BRIEF DESCRIPTION OF DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a block diagram illustrating an example embodiment of a RFID access control system.

FIG. 2 is a block diagram illustrating an example embodiment of a RFID reader.

FIGS. 3A-3B are block diagrams illustrating two example embodiments of a secure Wiegand interface.

FIG. 4 is a flow diagram illustrating operation of an RFID reader in accordance with one example embodiment.

FIG. 5 is a flow diagram illustrating operation of an access controller in accordance with one example embodiment.

### DESCRIPTION OF EXAMPLE EMBODIMENTS

Example embodiments are described herein in the context of an RFID access control system. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

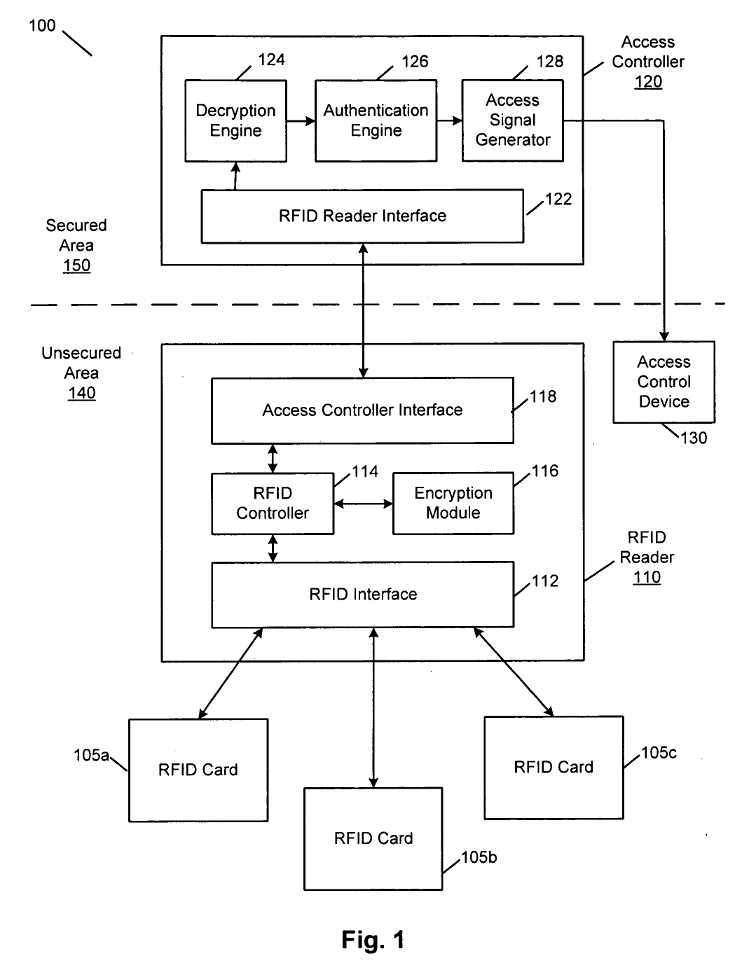

Turning now to FIG. 1, a block diagram of one example embodiment of an access control system 100 is shown. System 100 is an RFID-based access control system. System 100 may include at least one RFID card 105a, 105b, 105c, and the like, an RFID reader 110, an access controller 120 and an access control devices 130. RFID cards 105a, 105b, 105c may be used by card holders to gain access to restricted areas or services. In one embodiment, RFID cards 105a, 105b, 105c are proximity-based contactless integrated circuit (IC) cards. In another embodiment, RFID cards 105a, 105b, 105c may be contact-type IC cards. In one example embodiment, RFID cards 105a, 105b, 105c may include an integrated circuit (not shown) for storing and/or processing identification information associated with a card holder. RFID cards 105a, 105b, 105c may also include transmitter/receiver circuitry for transferring information, including identification information, from the card as well as receiving power from the RFID reader 110. When brought in proximity or contact with reader 110, RFID card 105 may transfer information stored therein using RF or electrical signals to RFID reader 110.

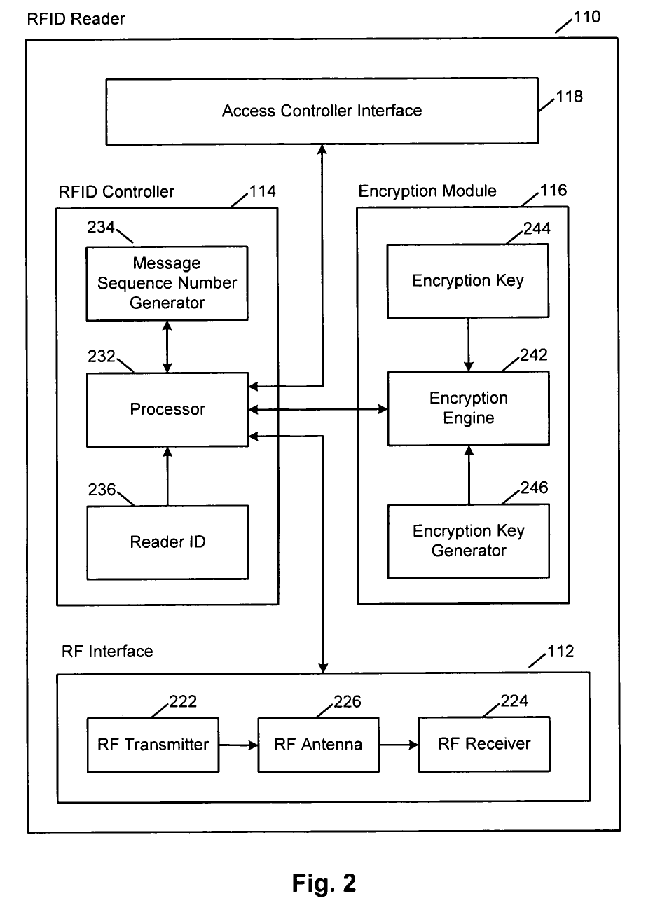

In one example embodiment, RFID reader 110 includes an RFID reader interface 112, RFID controller 114, encryption module 116 and access controller interface 118. RFID reader 110 is configured to receive RF signals (or electrical signals) from a proximate RFID cards 105a, 105b, 105c using RFID interface 112. One example embodiment of RFID interface 112 is depicted in more detail in FIG. 2. RFID interface 112 may include an RF transmitter 222, an RF receiver 224 and an RF antenna 226. Transmitter 222 may used to generate and transmit RFID polling signals through RF antenna 226, which are used to energize proximate RFID cards 105a, 105b, 105c. RF receiver 224 is configured to receive RF signals from proximate RFID cards 105a, 105b, 105c generated in response to the RFID polling signals. RF transmitter 222 and RF receiver 224 may operate at an RF frequency of 13.56 MHz in compliance with the ISO/IEC 14443 standard for contactless IC cards. Or at another frequency or in compliance with another suitable RFID standard.

In one example embodiment, RF antenna 226 may be implemented as a single mono-static RF antenna operable to transmit RF signals generated by RF transmitter 222 as well as receive RF signals generated by proximate RFID cards 105a, 105b, 105c. Switching between transmitting and receiving modes may require use of a circulator (not shown), which multiplexes the received and transmitted signals through a single port for use with a single antenna. In another example embodiment, RF antenna 226 may be implemented as a bi-static antenna, which includes two antennas, where one antenna is dedicated to transmitting RF signals and the other antenna is dedicated to receiving RF signals. Use of a bi-static antenna may improve sensitivity of antenna 226, thereby improving performance of RFID reader 110. Other known antenna configurations may also be utilized if desired.

In one example embodiment, RFID reader 110 includes an RFID controller 114 configured to process information, including identification information, received from proximate RFID cards 105a, 105b, 105c and generate messages to access controller 120 based on received identification information. In one example embodiment, RFID controller 114 may be implemented as a 8-bit PIC® programmable microcontroller (available from Microchip Technology, Inc. of Chandler, Ariz.). In alternative embodiments, controller 114 may be implemented as one of a general purpose microprocessor, a field programmable gate array, an application specific integrated circuit (ASIC), hardwired circuitry or other types of electrical circuits known to those of skill in the art. One example embodiment of RFID controller 114 is depicted in FIG. 2.

As depicted, controller 114 may include a processor 232 and system memory and related processor components (not explicitly shown), a message sequence number generator 234 and a reader ID 236. Processor 232 may store and execute program logic for operating various components of RFID reader 110, decoding data transmissions received from RFID cards 105a, 105b, 105c, performing arithmetic and logic operations, such as calculating message sequence numbers, generating access controller messages and other functions. Processor 232 is coupled to system memory storing program instructions, which may include, but is not limited to, volatile or non-volatile program memory types, such as ROM (Read Only Memory), PROM (Programmable Read Only Memory), EEPROM (Electrically Erasable Programmable Read Only Memory), FLASH memory, and other types of magnetic and optical storage media for storing RFID information and other data.

In one example embodiment, message sequence number generator 234 may be implemented as a simple counter incremented with each message to tag the message with a sequence number so that an out-of-sequence message may be identified as an invalid message and ignored. The sequence counter may be derived from any incrementing source, whether internally generated from the local reference crystal or clock or an external clock. In alternative embodiment, message sequence number generator 234 may be implemented in a more sophisticated manner as a pseudo random number generator, or the like, so that the sequence is more or less unpredictable to someone attempting to break in, however the sequence would be known to the RFID reader 110 and the access controller 120. In yet another alternative embodiment, a time/date stamp may be used for the message sequence number if such data is available. In one example embodiment, the message sequence number may be 32 bits in length, but may be larger or smaller number depending on the system requirement, configuration and other parameters.

In one example embodiment, a reader ID 236 may be a number assigned to a particular reader, such as a reader address, or it may similarly be implemented as a polling pseudo random number for verification purposes to prevent simple spoofing over a Wiegand-type interface. In one example embodiment, reader ID 236 by a unique serial number assigned to the RFID reader by its manufacturer. The size of the reader ID 236 may vary depending on system requirements, configuration and other parameters.

As indicated above, RFID controller 114 is operable to generate access controller messages based on information received from RFID cards 105a, 105b, 105c. In one example embodiment, an access controller message may include at least a portion of identification information received from RFID cards 105a, 105b, 105c and various security parameters. For example, in addition to identification information, the message may include an RFID reader ID (or identifier) 236, as described above. In one example embodiment, reader identifier 236 may be 16 bits in length. Size of the identifier 236, however, may vary depending on the number of RFID readers 110 used in the access control system 100 and other considerations known to those of skill in the art. Including an RFID reader identifier 236 in a message to access controller 120 enables access controller 120 to determine whether the received message was actually generated by the RFID reader from which it was received or whether the received message was counterfeited or spoofed, as will be described in a greater detail herein below.

In one example embodiment, RFID reader 110 further includes encryption module 116, which encrypts messages from the RFID reader 110 directed to the access controller 120. Encryption module 116 may in one embodiment include an encryption engine 242, one or more encryption keys 244 and an encryption key generator 246. In one example embodiment, encryption engine 242 may implement a symmetric encryption algorithm, such as a block cipher or the like. In another example embodiment, encryption engine 242 may implement an asymmetric encryption algorithm, such as public-key encryption algorithm or the like. To that end, encryption module 116 may store one or more symmetric or asymmetric encryption keys 244 used for encryption of outgoing access controller messages. Alternatively or in addition, encryption module 116 may include an encryption key generator 246, such as a pseudorandom number generator, configured to generate new encryption keys. During encryption, encryption engine 242 may place message fields in any order, or it may scramble bits of some or all data field, so that they are not sent as a continuous field.

In one example embodiment, encryption module 116 may be implemented as a software module on new RFID reader devices or provided as a program upgrade to the existing RFID readers devices. In another example embodiment, encryption module 116 may be implemented as a firmware, i.e., a computer program that is embedded in a hardware device, such as a microchip or other type of intergrated circuit. The firmware embodiment of the encryption module 116 may be especially useful to retrofit RFID readers that do not support software upgrades. In this case, the encryption firmware may be provided as an auxiliary device, which is added to the existing RFID reader system.

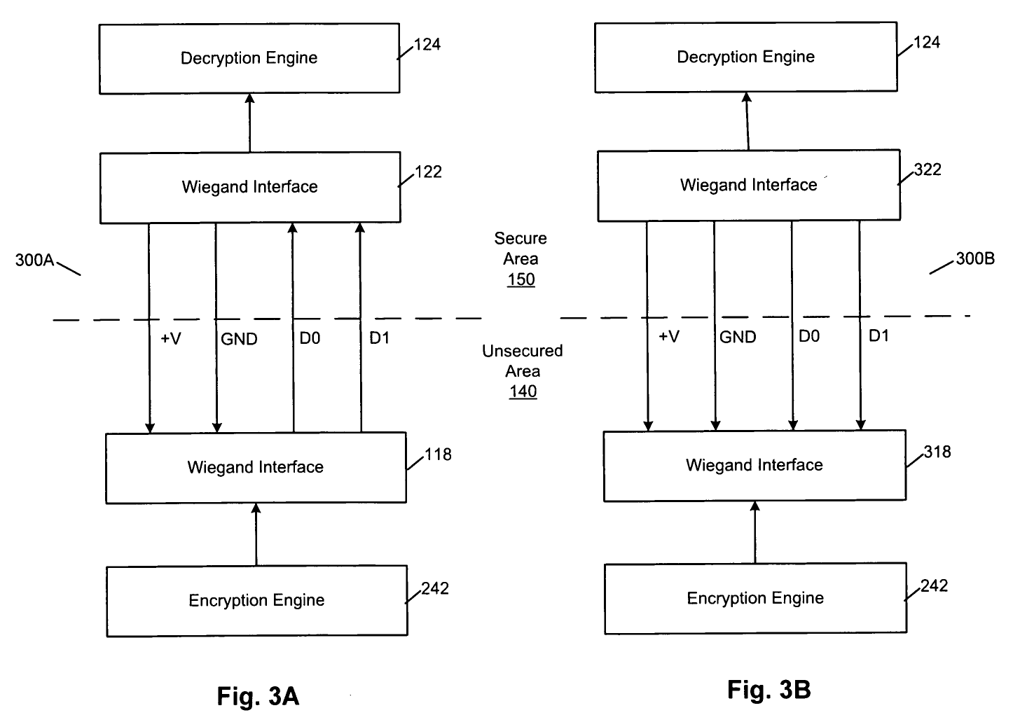

In one example embodiment, RFID reader 110 further includes an access controller interface such as Wiegand interface 118, which facilitates transmission of encrypted messages to access controller 120. One exemplary embodiment of Wiegand interface is depicted in FIG. 3A. As depicted, interface 300A may include a voltage line V+, a ground line GND and two unidirectional data lines DØ and D1, which facilitate transfer of encrypted Wiegand messages from RFID reader 110 to access controller 120. As indicated above, an encrypted Wiegand message may include RFID identifier, message sequence number and Wiegand data. The total size of such message may be 74 bits, which includes 16 bits for RFID identifier, 32 bits for message sequence counter and 26 bits or more of Wiegand data; however, smaller or larger size messages may be used depending on the application in which interface 300A is being used. Those of skill in the art will recognize that such factors as transaction time, system security and maintenance factors will have an impact on the final bit-size of encrypted messages.

In one example embodiment, access control system 100 further includes an access controller 120. Access controller 120 may be implemented as a computer system, such as a network server, operable to determine based on the information received from RFID reader 110 whether a holder of RFID card 105a may receive access to the restricted area. Unlike RFID reader 110, which is located in an unsecure area 140, which may be accessible to a system attacker, access controller 120 may be located in a remote, secured area 150. With reference to FIGS. 1-3, access controller 120 may include an RFID reader interface 122, a decryption engine 124 and an authentication engine 126. In one example embodiment, interface 122 includes a Wiegand interface configured to receive encrypted Wiegand messages from RFID reader 110. In another example embodiment, access controller 120 may include several Wiegand interfaces 122 for communicating with a plurality of RFID readers 110 positioned in various remote locations.

In one example embodiment, access controller 120 includes a decryption engine 124 configured to decrypt Wiegand message received from RFID reader 110. In particular, decryption engine 124 implements a decryption algorithm corresponding to the encryption algorithms used by the encryption engine 242 of RFID reader 110. Thus, if encryption engine 242 uses a block cipher to encrypt outgoing messages, decryption engine 124 uses a corresponding decryption algorithm and the same cryptographic key as the key used by the encryption engine 242. Likewise, if encryption engine 242 uses a public-key encryption algorithm, decryption engine 124 implements an appropriate decryption algorithm with private key (i.e., decryption key) corresponding to the public key (i.e., encryption key) used by the encryption engine 242.

A Wiegand interface may also be used to communicate cryptographic keys information using Wiegand messages from access controller 120 to RFID reader 110. To that end, in one example embodiment, a second Wiegand interface may be provided to facilitate exchange of cryptographic keys, as depicted in FIG. 3B. Wiegand interface 300B includes a voltage line V+, a ground line GND and two unidirectional data lines DØ and D1. However, direction of data lines is reversed, as compared with interface 300A, so that data can be communicated from access controller 120 to RFID reader 110. Therefore, access controller 120 may transmit cryptographic keys to RFID reader 110 using Wiegand messages. Such messages may be standard 26 bit Wiegand messages, or may have different size depending, for example, on the size of the cryptographic keys and other transmitted information. In one example embodiments, Wiegand messages transmitted through interface 300B may be encrypted using encryption engine 242.

One example communication method using Wiegand interfaces 300A and 300B is described next. In the case of block cipher or public key encryption, access controller 120 may use Wiegand interface 300B to send an encryption key (e.g., public key) to RFID reader 110. The reader may store the received encryption key in its system memory and then use the stored key to encrypt outgoing access controller messages. In one example embodiment, encryption key updates may be performed periodically, or with every message to be sent from RFID reader to access controller 110. For instance, reader 110 may signal to access controller 120 that a RFID card 105 has been read by pulling low one or both of data lines of Wiegand interface 300A, until such time access controller 120 transmits to the reader a new encryption key. Then, RFID reader 110 may signal that the new key was received by pulling high data lines of interface 300A. Shortly thereafter, the reader may send the encrypted Wiegand message to the access controller 120 using the newly assigned encryption key using Wiegand interface 300A.

In one example embodiment, access controller 120 further includes an authentication engine 126 configured to authenticate the decrypted messages based on the RFID reader identifier and the message sequence counter contained therein. In one example embodiment, authentication engine 126 may use RFID reader identifier 236 to determine whether a received message was generated by the RFID reader from which this message was received. To that end, authentication engine 126 is configured to compare the RFID reader identifier retrieved from the currently received message with RFID reader identifiers associated with the Wiegand interface 122. If two RFID reader identifiers match, the received message is deemed to be generated by the associated RFID reader 110. However, if two RFID identifiers do not match the received message may be deemed counterfeited and access may be denied to the holder of RFID card 105.

In another embodiment, authentication engine 126 may use a message sequence number to determine whether the newly received message has not been previously transmitted. To that end, authentication engine 126 may store in a memory of access controller 120 a message sequence number retrieved from the previously received message in accordance with one example embodiment. The authentication engine 126 may compare the stored message sequence number with a message sequence number retrieved from the newly received message. If the new message sequence number is greater than the stored message sequence number, the new message may be deemed to be authentic. However, if the new message sequence number is equal to or less than the stored messages sequence number, the newly received message may be deemed counterfeited and access should be denied. In the embodiment where a pseudo random number is used as message sequence number, the authentication engine 126 may use a predefined algorithm to generate a pseudo random number and compare it with the message sequence number retrieved from the newly received message.

Having established authenticity of the received message, access controller 120 may determine whether the received identification information belongs to the authorized user. To that end, access controller 120 may query a user database (not depicted) with provided identification information to determine whether holder of RFID card 105a has access rights to the restricted area or resources to which access is being requested. If query results are positive, access controller 120 may send an access signal using access signal generator 128 to the access control device 130, such as a mechanical or magnetic lock, thereby allowing the RFID card holder to access the restricted area or resources. If query results are negative, access controller 120 may deny access to the restricted area or resources to the RFID card holder by not transmitting such an access signal.

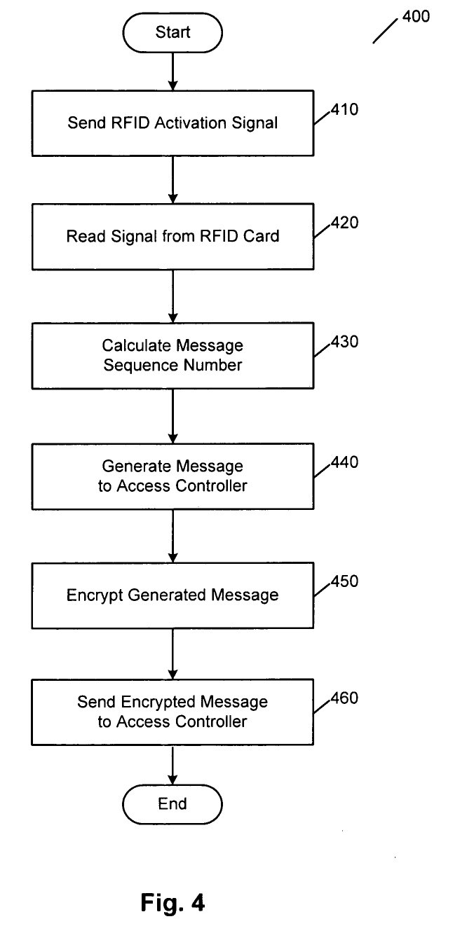

FIG. 4 is a process flow diagram which illustrates operation of RFID reader 110 in accordance with one example embodiment. At 410, the RFID reader 110 periodically transmits RFID polling signals. At 420, RFID reader 110 receives in response to the polling signal a RFID card signal from a proximate RFID card 105a. The received signal may include identification information associated with the holder of RFID card 105a. At 430, RFID reader 110 may calculate a new message sequence number. At 440, RFID reader 110 generates a message to access controller 120 based on the received identification data. The message may further include an RFID reader identifier 236 and/or the message sequence number. At 450, RFID reader 110 may encrypt the generated message. At 460, RFID reader 110 may send the encrypted message to access controller 120 via a wired interface such as a Wiegand interface.

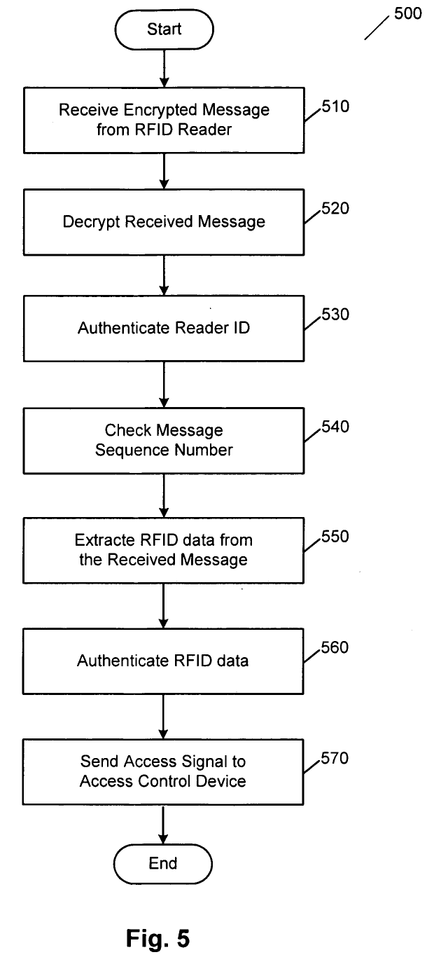

FIG. 5 is a process flow diagram which illustrates operation of access controller 120 in accordance with one example embodiment. At 510, access controller 120 receives an encrypted RFID reader message via a wired interface, such as a Wiegand interface. At 520, access controller 120 decrypts the received message. At 530, access controller 120 retrieves RFID identifier 236 from the decrypted message and authenticates RFID identifier 236 by comparing it with a stored RFID identifier. At 540, access controller 120 retrieves the message sequence number from the received message and authenticates it by comparing it with a stored message sequence number from the previous message or by calculating an expected message sequence number and comparing the two. At 550, access controller 120 retrieves identification information from the received message. At 560, access controller 120 determines based on the identification information whether the RFID card holder has the right to access the restricted area or services to which access is being requested. Finally, at 570, access controller 120 may generate a signal to the access control device 110 to allow access to the restricted area to the RIFD card holder.

The block and flow diagrams in FIGS. 1-5 have been simplified to include primarily elements and steps of operation of various example embodiments of access control system. Those of ordinary skill in the art will readily identify other elements and steps that might also be included as desired or required. The various elements and/or steps may be separated, combined or reordered as desired or required. Other means of implementing the access control system are also known to those of skill in the art and are not intended to be excluded. While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. An access control system, comprising:
an RFID reader, including
an RFID card interface configured to receive an RFID signal including at least some identification data associated with a holder of an RFID card;
a controller configured to
retrieve the identification data from the received RFID signal, and
generate a message responsive to the identification data, wherein the message further includes an RFID reader identifier and a message sequence number;
an encryption engine configured to encrypt the generated message; and
an access controller interface configured to send the encrypted message to a remote access controller; and
an access controller, including
an RFID reader interface configured to receive the encrypted message;
a decryption engine configured to decrypt the received message;
an authentication engine configured to authenticate the decrypted message based on the RFID reader identifier and the message sequence number; and
an access control signal generator configured to generate an access control signal responsive to the received identification data.

2. The system of claim 1, wherein the access controller interface and RFID reader interface include Wiegand-type interfaces.

3. The system of claim 1, wherein the encryption engine is configured to encrypt the access controller message using a block cipher.

4. The system of claim 1, wherein the encryption engine is configured to encrypt the access controller message using a public key encryption algorithm.

5. The system of claim 1, wherein the controller is configured to calculate the message sequence number before sending a message to the access controller.

6. The system of claim 1, wherein the authentication engine of the access controller is configured to compare the message sequence number retrieved from the received message with previously received, stored message sequence number.

7. The system of claim 1, wherein the authenticating engine of the access controller is configured to compare the RFID reader identifier retrieved from the received message with one or more stored RFID reader identifiers.

8. The system of claim 1, wherein access controller is configured to determine whether identification data corresponds to an authorized RFID holder.

9. An access control method, comprising:
receiving a RFID card signal from a RFID card, the signal including at least an identification data associated with the holder of the RFID card;
retrieving the identification data from the received RFID card signal;
generating an access controller message based on the received identification data, the message further including a RFID reader identifier and a message sequence number;
encrypting the generated access controller message; and
sending the encrypted message to the access controller via an access controller interface.

10. The method of claim 9, wherein the access controller interface includes Wiegand interface.

11. The method of claim 9, wherein encrypting the access controller message includes encrypting using a block cipher or encrypting using a public-key encryption algorithm.

12. The method of claim 9, further comprising incrementing the message sequence counter after sending a message to the access controller.

13. An access control method, comprising:
receiving an encrypted RFID reader message via a RFID reader interface;
decrypting the received message, the message including at least a RFID reader identifier, a message sequence number and an identification data;
retrieving the RFID reader identifier and the message sequence number from the decrypted message;
authenticating the decrypted message based on the RFID reader identifier and the message sequence number; and
generating an access control signal based on the received identification data.

14. The method of claim 13, wherein the access controller interface includes Wiegand interface.

15. The method of claim 13, wherein decrypting the access controller message includes decrypting using a block cipher or decrypting using a public-key decryption algorithm.

16. The method of claim 13, wherein authenticating the decrypted message further includes comparing the message sequence number retrieved from the received message with previously received stored message sequence number.

17. The method of claim 13, wherein authenticating the decrypted message further includes comparing the message sequence number retrieved from the received message with a generated pseudo random number.

18. The method of claim 13, wherein authenticating the decrypted message further includes comparing the RFID reader identifier retrieved from the received message with one or more stored RFID reader identifiers.

19. The method of claim 13, wherein the identification data is associated with a holder of a RFID card.

20. The method of claim 13, wherein generating the access control signal includes determining whether identification data corresponds to an authorized RFID holders.
